(19) United States
(12) Patent Application Publication
(10) Pub. No.: US 2025/0178966 A1
(43) Pub. Date: Jun. 5, 2025

(54) BATCH FOR THE PRODUCTION OF A CARBON BONDED PRODUCT AND PROCESS FOR THE PRODUCTION OF A CARBON BONDED BRICK

(71) Applicant: REFRACTORY INTELLECTUAL PROPERTY GMBH & CO. KG, Wien (AT)

(72) Inventors: Rainer NEUBÖCK, Graz (AT); Laura RECHBERGER, Kapfenberg (AT); Hartwig KUNANZ, Trofaiach (AT)

(21) Appl. No.: 18/876,607

(22) PCT Filed: Jun. 12, 2023
(86) PCT No.: PCT/EP2023/065635

§ 371 Date: Dec. 18, 2024

(30) Foreign Application Priority Data
Jun. 20, 2022 (EP) 22179836.6

(51) Int. Cl. C04B 35/043; C04B 35/101; C04B 35/622; C04B 35/634

(52) U.S. Cl. CPC C04B 35/043; C04B 35/101; C04B 35/62204; C04B 35/63496

(57) ABSTRACT

The invention relates to a batch for the production of a carbon bonded product and to a process for the production of a carbon bonded product.

The invention relates to a batch for the production of a carbon bonded product and to a process for the production of a carbon bonded product.

Carbon bonded products are known in particular in the form of carbon bonded refractory bricks, i.e., bricks which have a carbon bond and which are exposed to high temperatures during their application. A typical application of such carbon bonded refractory bricks is, for example, their use in metallurgical plants for the production and treatment of liquid steel.

A batch comprising a refractory component, a carbon component, and an organic binder is regularly used in the manufacture of carbon bonded refractory products. The refractory component comprises one or more refractory raw materials, for example magnesia-based raw materials or alumina-based raw materials. The carbon component is a carrier of free carbon and serves to form the carbon bond. Typical carbon components are based on graphite. The organic binder, on the one hand, gives the batch green strength. On the other hand, the organic binder can also participate in the formation of the carbon bond.

The batch comprising the above components is heated to temperatures at which a carbon bond is formed from the carbon component and the organic binder. After firing, a carbon bonded refractory product is obtained.

The production of the refractory raw materials that make up the refractory component is energy-intensive. In particular, these raw materials are regularly produced with a high input of thermal energy. On the one hand, this high input of thermal energy is disadvantageous for economic reasons, since it is associated in particular with high costs. On the other hand, the high input of thermal energy is also disadvantageous for ecological reasons in particular, since it is inevitably associated with a considerable formation of carbon dioxide. This carbon dioxide, however, is released into the atmosphere, where it contributes to the greenhouse effect.

A typical refractory raw material for a refractory component is magnesia, i.e., a raw material mainly consisting of magnesium oxide (MgO). The main source for the production of magnesia is magnesite, i.e., magnesium carbonate (MgCO₃). To produce magnesia from magnesite, it has to be calcined, requiring heating magnesite to temperatures above 1,700° C., which involves a significant input of thermal energy.

Therefore, for ecological and economic reasons, there has been no lack of attempts in the past to reduce the input of thermal energy required to provide a batch for the production of a carbon bonded refractory.

For example, attempts have been made to recycle used carbon bonded refractory material or to reuse it in the manufacture of new carbon bonded refractory products. The advantage of such a use of used refractory material with a carbon bond as refractory component is, in particular, that this material can be made available with a much lower input of thermal energy. This is because numerous thermal processes that involve a considerable input of energy, such as the calcination of magnesite indicated above, do not have to be used again for the provision of such used refractory material.

However, the use of used refractory material with a carbon bond as a raw material for the production of new carbon bonded refractory products has proven to be extremely problematic. This is because the properties of carbon bonded refractory products produced on the basis of such used refractory material with a carbon bond were greatly deteriorated compared to the properties of carbon bonded refractory products manufactured without such used refractory material. In some cases, the properties were so poor that the produced products could not be put to any useful use.

It is an object of the invention to provide a batch for the production of a carbon bonded refractory product, the components of which can be provided with a low input of energy, in particular thermal energy. In particular, it should be possible to provide the components with a lower input of energy than is possible for the batches known from the prior art.

In particular, it is an object of the invention to provide such a batch which comprises used refractory material with a carbon bond and from which carbon bonded refractory products with good refractory properties can be produced.

In particular, it is an object of the invention to provide such a batch which may comprise a considerable high proportion of used refractory material with a carbon bond and from which carbon bonded refractory products with good or at least still acceptable refractory properties can be produced.

To solve this problem, according to the invention, it is provided a batch for the production of a carbon bonded refractory product comprising the following components:
a refractory component; and
an organic binder; wherein
said refractory component comprises at least one used refractory material having a carbon bond and at least one used refractory material without a carbon bond; wherein
said at least one used refractory material having a carbon bond has a particle-size distribution having a first d50 value; and
said at least one used refractory material without a carbon bond has a particle-size distribution having a second d50 value; and wherein
said first d50 value is higher than said second d50 value.

The invention is based, inter alia, on the finding according to the invention that the refractory properties of a carbon bonded refractory product may be deteriorated, in particular, if the batch which has been used for the production of the product comprises in the fine fraction exclusively used refractory material with a carbon bond. According to the invention, it has now been recognized that the properties of a carbon bonded refractory product produced from used refractory material can be improved if the fine fraction of the batch comprises portions of used refractory material without a carbon bond. Further, according to the invention, it turned out that, for the production of a carbon bonded refractory product, using used material without a carbon bond in the fines results in similar properties as using native (i.e., non-used) material without a carbon bond in the fines.

The basic refractory component of the batch according to the invention comprises at least one used refractory material with a carbon bond and at least one used refractory material without a carbon bond. The at least one used refractory material with a carbon bond has a grain size distribution with a first d50 value, and the at least one used refractory material without a carbon bond has a grain size distribution with a second d50 value. Thereby, the first d50 value is higher than the second d50 value according to the invention. The used refractory material with a carbon bond is thus “coarser” with regard to its grain size distribution and the used refractory material without a carbon bond is thus “finer”.

As known from the prior art, the d50 value indicates a grain size for a grain mixture in which 50% by mass of the grain mixture has a grain size according to the d50 value and below, and 50% by mass of this grain mixture has a grain size above the d50 value.

Accordingly, the first d50 value indicates that 50% by mass of the at least one used refractory material with a carbon bond has a grain size according to the first d50 value and below, and 50% by mass of the at least one used refractory material with a carbon bond has a grain size above the first d50 value, the mass fractions being in each case based on the total mass of the at least one used refractory material with a carbon bond.

Accordingly, the second d50 value indicates that 50% by mass of the at least one used refractory material without a carbon bond has a grain size according to the second d50 value and below, and 50% by mass of the at least one used refractory material without a carbon bond has a grain size above the second d50 value, the mass fractions being in each case based on the total mass of the at least one used refractory material without a carbon bond.

The standard used for the determination of the d50 value depends on the grain size of the grain fraction for which the d50 value is to be determined. If the grain fraction does not comprise grains with a grain size above 1,000 μm, the d50 value is determined by laser diffraction according to the standard ISO 13320:2020-1 “Particle size analysis—Laser diffraction methods”. If the grain fraction comprises grains with a grain size above 1,000 μm, the d50 value is determined by sieving according to the standard DIN EN 1402-3. Of course, if the grain fraction comprises grains with a grain size above and below 1,000 μm, both standards can be combined with each other for the determination of the d50 value. Preferably, the d50 value of the at least one used refractory material having a carbon bond is determined by sieving according to the standard DIN EN 1402-3 and the d50 value of the at least one used refractory material without a carbon bond is determined by laser diffraction according to the standard ISO 13320:2020-1.

Surprisingly, it was found according to the invention that on the basis of a batch according to the invention a carbon bonded refractory product can be produced, the refractory properties of which are good and still acceptable so that they can be used for the most standard applications of carbon bonded refractory products. In particular, the density and cold crushing strength of such carbon bonded refractory product are good and acceptable. In particular, the density and cold crushing strength of such carbon bonded refractory product produced on the basis of a batch according to the invention may be improved compared to a product entirely produced from used material with a carbon bond.

The carbon bonded refractory product, which is producible by the batch according to the invention, may in principle represent any carbon bonded refractory product, preferably a shaped carbon bonded refractory product, particularly preferably a carbon bonded refractory brick.

The batch according to the invention is used to produce a carbon bonded refractory product. This carbon bond is formable from carbon which the batch according to the invention comprises. One source of this carbon is the carbon content of the used refractory material having a carbon bond. Another source of carbon may be the organic binder. Another source of carbon may be another carbon-based component that the batch may also comprise, as discussed further below.

A “used” refractory material in the sense of the invention is a refractory material as a secondary raw material, i.e., a refractory material that has already been used for its original purpose and is now reused for another purpose, namely for providing the batch according to the invention. In this respect, the batch according to the invention is a recyclate. The provision of the batch according to the invention or the process for producing the batch according to the invention is therefore recycling. This applies in particular because the used refractory products provided for the batch according to the invention-without their use in the context of the invention-represent waste materials and are now used for a new purpose in the context of the recycling according to the invention.

The original purpose of the used refractory material with or without carbon bond may have been its use in an industrial high-temperature aggregate, in particular in an industrial high-temperature aggregate for the treatment of metal or glass melts. An industrial high-temperature aggregate for the treatment of molten metals may in particular be a metallurgical plant. An industrial high-temperature aggregate for the treatment of molten glass may be, in particular, a glass tank. The used refractory material having a carbon bond may particularly preferably be a material already used in a metallurgical plant. The used refractory material without a carbon bond may preferably be a material already used in steel plants preferably in safety linings for, e.g., converters, ladles or electric arc furnaces.

According to the invention, it has been found that the refractory properties of a carbon bonded refractory product producible from the batch according to the invention can be improved if the first d50 value is significantly higher than the second d50 value. According to a preferred embodiment, it is provided that the first d50 value is higher than the second d50 value by at least a factor of 4, more preferably by at least a factor of 10, more preferably by at least a factor of 20, and even more preferably by at least a factor of 30. According to a further development of this inventive idea, it is provided that the first d50 value is higher than the second d50 value by a factor in the range from 4 to 150, more preferably by a factor in the range from 10 to 150, more preferably by a factor in the range from 20 to 150 and even more preferably by a factor in the range from 30 to 100.

Preferably, it is provided that the at least one refractory material having a carbon bond is present in a relatively coarse grain size. According to a preferred embodiment, it is provided that the first d50 value is at least 500 μm and is particularly preferably in the range of 500 μm to 3,000 μm. Preferably, it is provided that the at least one refractory material without a carbon bond is present in a small grain size or in a fine grain size, respectively. According to a preferred embodiment, it is provided that the second d50 value does not exceed 400 μm and, according to a further development of this invention, is in the range of 10 μm to 400 μm and even more preferably in the range of 30 μm to 100 μm.

According to an embodiment of the invention it is provided that the mass percentage of the particles of said at least one used refractory material having a carbon bond having a particle size below said second d50 value is smaller than the mass percentage of the particles of said at least one used refractory material without a carbon bond having a particle size below said second d50 value, each of the mass percentages based on the total mass of said refractory component.

Preferably, the at least one refractory material having a carbon bond is present in a greater mass percentage in the refractory component than the at least one used refractory material without a carbon bond.

According to one embodiment, it is provided that said at least one used refractory material having a carbon bond is present in a proportion in the range of 80 to 99% by mass and said at least one used refractory material without a carbon bond is present in a proportion in the range of 1 to 20% by mass, each based on the total mass of said refractory component. More preferably, it is provided that said at least one used refractory material having a carbon bond is present in a proportion in the range of 85 to 95% by mass and said at least one used refractory material without a carbon bond is present in a proportion in the range of 5 to 15% by mass, each based on the total mass of said refractory component.

The at least one used refractory material having a carbon bond can in principle be present in the form of any used refractory material having a carbon bond known from the prior art.

According to a preferred embodiment it is provided that said at least one used refractory material having a carbon bond is comprised of at least one of the following: used carbon bonded magnesia-based refractory materials and used carbon bonded alumina-magnesia-based refractory materials.

The used carbon bonded magnesia-based refractory materials are used carbon bonded refractory materials based on magnesia. Particularly preferred are carbon bonded magnesia bricks, i.e., so-called MgO—C bricks. Preferably, the used carbon bonded magnesia-based refractory materials have a chemical composition with at least 50% by mass MgO, further preferably with at least 80% by mass MgO and still further preferably with at least 90% by mass MgO. Preferably, the proportion of other oxides is below 50% by mass, more preferably below 20% by mass and even more preferably below 10% by mass. Preferably, the proportion of MgO is in the range from 50 to 99% by mass and the proportion of other oxides in the range from 1 to 50% by mass, more preferably the proportion of MgO is in the range from 80 to 99% by mass and the proportion of other oxides in the range from 1 to 20% by mass, and even more preferably the proportion of MgO is in the range from 90 to 99% by mass and the proportion of other oxides in the range from 1 to 10% by mass. The other oxides are preferably at least one of the following oxides: Al₂O₃, CaO and SiO₂. The above data in % by mass is based on the total mass of the used carbon bonded magnesia-based refractory material.

The used carbon bonded alumina-magnesia-based refractory materials are used carbon bonded refractory materials based on magnesia and alumina. Additionally, or alternatively, the used carbon bonded alumina-magnesia based refractory materials can be used carbon bonded refractory material based on magnesia, alumina and spinel (i.e., MgO. Al₂O₃ or MgAl₂O₄). Particularly preferred are carbon bonded alumina-magnesia-carbon bricks, i.e., so-called AMC bricks. Preferably, the used carbon bonded alumina-magnesia-based refractory materials have a chemical composition with at least 50% by mass MgO and Al₂O₃, further preferably with at least 80% by mass MgO and Al₂O₃ and still further preferably with at least 90% by mass MgO and Al₂O₃. Preferably, the proportion of other oxides is below 50% by mass, more preferably below 20% by mass and even more preferably below 10% by mass. Preferably, the proportion of MgO and Al₂O₃ is in the range from 50 to 99% by mass and of other oxides in the range from 1 to 50% by mass, more preferably the proportion of MgO and Al₂O₃ is in the range from 80 to 99% by mass and the proportion of other oxides in the range from 1 to 20% by mass and even more preferably the proportion of MgO and Al₂O₃ is in the range from 90 to 99% by mass and the proportion of other oxides in the range from 1 to 10% by mass. The other oxides are preferably at least one of the following oxides: CaO and SiO₂. The above data in % by mass is based on the total mass of the used carbon bonded alumina-magnesia-based refractory material.

The at least one used carbon bonded refractory material, in particular the aforementioned used carbon bonded refractory materials, may have the usual proportions of carbon known from the prior art, for example proportions of carbon in the range of 1 to 15% by mass, based on the total mass of the used carbon bonded refractory materials. These carbon fractions are not included in the aforementioned mass fractions of oxides, since they represent a loss of ignition when the oxide fractions are determined.

According to a preferred embodiment said at least one used refractory material without a carbon bond is comprised of at least one of the following: used magnesia-based refractory materials and used alumina-magnesia-based refractory materials.

The used magnesia-based refractory material may generally be any used magnesia-based refractory material without a carbon bond known from the prior art. Preferably, it is a sintered used magnesia-based refractory material. Particularly preferably, the used magnesia-based refractory material is a sintered used magnesia refractory brick. Preferably, the chemical composition of the used magnesia-based refractory material may correspond to the aforementioned chemical composition of the used carbon bonded magnesia-based refractory material.

The used alumina-magnesia-based refractory material may generally be any used alumina-magnesia-based refractory material without a carbon bond known in the prior art, e.g., spinel (MgAl₂O₄). Preferably, it is a sintered used alumina-magnesia-based refractory material. Particularly preferably, the used alumina-magnesia-based refractory material is a sintered used alumina-magnesia refractory brick. Preferably, the chemical composition of the used alumina-magnesia-based refractory material may correspond to the aforementioned chemical composition of the used carbon bonded alumina-magnesia-based refractory material.

According to a preferred embodiment said at least one used refractory material having a carbon bond is comprised of at least one of the following: magnesia-based refractory materials having a carbon bond and alumina-magnesia-based refractory materials having a carbon bond; and wherein said at least one used refractory material without a carbon bond is comprised of magnesia-based refractory materials without a carbon bond and alumina-magnesia-based refractory materials without a carbon bond.

According to a particularly preferred embodiment said at least one used refractory material having a carbon bond is magnesia-based refractory material having a carbon bond; and wherein said at least one used refractory material without a carbon bond is magnesia-based refractory material without a carbon bond.

According to one embodiment said at least one used refractory material having a carbon bond is doloma-based refractory material having a carbon bond; and wherein said at least one used refractory material without a carbon bond is at least one of the following: doloma-based refractory material without a carbon bond and magnesia-based refractory material without a carbon bond.

According to one embodiment, the refractory component of the batch according to the invention is only comprised of the at least one used refractory material having a carbon bond and the at least one used refractory material without a carbon bond.

With respect to its chemical composition, the batch according to the invention is preferably magnesia-based, i.e., based substantially on MgO. According to one embodiment, it is provided that the batch comprises at least 50% by mass of MgO, more preferably at least 80% by mass of MgO and even more preferably at least 90% by mass of MgO. It is further preferably provided that the batch comprises at most 50% by mass of other oxides, more preferably at most 20% by mass and even more preferably at most 10% by mass of other oxides. According to one embodiment, it is provided that the batch comprises 50 to 99% by mass MgO and 1 to 50% by mass of other oxides, more preferably 80 to 99% by mass MgO and 1 to 20% by mass of other oxides, and still more preferably 90 to 99% by mass MgO and 1 to 10% by mass of other oxides, in each case based on the total mass of the batch. The other oxides are preferably at least one of Al₂O₃, CaO and SiO₂. Where a chemical composition is given in this application, it is determined by XRF in accordance with the standard ISO 12677.

According to the invention, it surprisingly turned out that the batch according to the invention may comprise a considerable high proportion of used refractory material with a carbon bond, by which a carbon bonded refractory product with acceptable refractory properties can be produced from the batch. Accordingly, it may be provided that the batch according to the invention comprises the at least one used refractory material having a carbon bond in a proportion of at least 80% by mass or even in a proportion of at least 90% by mass, based on the total mass of the refractory component.

The batch according to the invention may further preferably comprise a carbon-based component as known from the prior art for batches for the production of carbon bonded refractory products. The carbon-based component may comprise at least one carbon-based raw material. Preferably, the carbon-based component comprises a carbon-based raw material in the form of graphite, particularly preferably in the form of flake graphite.

According to one embodiment, the batch comprises a carbon-based component in a proportion of from 1 to 15% by mass, and more preferably in a proportion of from 2 to 10% by mass, each based on the total mass of the batch.

The organic binder may be in the form of at least one binder known in the prior art for batches for the production of carbon bonded refractory products. Preferably, the organic binder is in the form of at least one of the following organic binders: Pitch or synthetic resin. The organic binder in the form of synthetic resin most preferably is in the form of phenolic resin.

Preferably, the organic binder is present in a proportion in the range from 1 to 10% by mass, more preferably in a proportion in the range from 2 to 7% by mass, in each case based on the total mass of the batch without the organic binder.

According to a preferred embodiment, it is provided that the organic binder is in the form of a synthetic resin and comprises lignin. Surprisingly, it has been found in accordance with the invention that a carbon bonded refractory product can be produced from a batch comprising an organic binder in the form of lignin. Binders comprising lignin are known as temporary binders for refractory batches, but not for refractory batches for the production of carbon bonded products. Surprisingly, it has now been found in accordance with the invention that a batch for the production of carbon bonded refractory products can also comprise a binder in the form of lignin. The advantage of an organic binder comprising lignin is in particular that the energy balance of the batch according to the invention can be further improved. This is because lignin can be made available as a waste material from paper production or as a renewable raw material. In this respect, the organic binder of the batch according to the invention can be partially substituted by lignin. Insofar, it has to be taken into account that binders used for batches for the production of carbon bonded refractory products, in particular phenolic resin, must be produced as primary raw materials with high energy input. By having the organic binder comprising lignin, the energy input of the batch according to the invention can be further improved.

Preferably, the organic binder comprises at least 10% by mass of lignin, based on the total mass of the organic binder. It has been found that the organic binder cannot be completely substituted by lignin, since a carbon bonded refractory product made from such a batch would deteriorate in terms of its properties if the batch were to comprise exclusively an organic binder in the form of lignin. According to a preferred embodiment, it is therefore provided that the organic binder comprises lignin in a proportion in the range of 10 to 50% by mass, based on the total mass of the organic binder. Preferably, the organic binder comprises 10 to 50% by mass lignin and 50 to 90% by mass phenolic resin, each based on the total mass of the organic binder.

As is well known in the art, the batch according to the present invention may further comprise any antioxidant, e.g., a powder of metallic aluminum, silicon or alloys thereof.

It is also an object of the invention to provide a process for the production of a carbon bonded refractory product comprising the following steps:
providing the batch according to the invention;
subjecting the batch to temperature to produce a carbon bonded refractory product.

Preferably, the batch is subjected to a temperature at which the carbon components in the batch coke and thereby form a carbon bond. Preferably, the batch is subjected to a temperature in the range of 200 to 350° C. At a temperature in this temperature range, the carbon components in the batch may coke and thereby form a carbon bond. The temperature may come from used process heat.

Before the batch is subjected to temperature, the batch may preferably be shaped, preferably by pressing. Preferably, the batch is shaped, particularly by pressing, into a green body. By subsequently subjecting the green body to temperature, a carbon bonded refractory brick is made from the green body.

Before the batch is subjected to temperature and, to the extent that the batch should be formed, before pressing, the batch is preferably mixed to homogenize the batch. Preferably, the batch may be mixed in a mixer.

In all other respects, a carbon bonded refractory product can be made from the batch according to the invention by technologies known in the prior art.

As stated above, the at least one used refractory material having a carbon bond may in particular represent a refractory material that has already been used in an aggregate for treating a molten metal. According to one embodiment, it may therefore be provided that the process step of providing the batch is preceded by the following process step:
breaking out used refractory material having a carbon bond from at least one aggregate for treating molten metal and then providing said broken out used refractory material to provide said at least one used refractory material having a carbon bond.

Further, as stated above, the at least one used refractory material without a carbon bond may represent a refractory material that has already been used in an aggregate for treating molten metal or molten glass. According to one embodiment, it may therefore be provided that the process step of providing the batch is preceded by the following process step:
breaking out used refractory material without a carbon bond from at least one aggregate for treating molten metal or for treating a glass melt and then providing said broken out used refractory material to provide said at least one used refractory material without a carbon bond.

As set forth above, it surprisingly turned out that from the batch according to the invention a carbon bonded refractory product with acceptable refractory properties can be produced, in particular, even if the batch comprises a considerable high proportion of used refractory material with a carbon bond. Insofar, it turned out that a carbon bonded refractory product with an acceptable density and an acceptable cold crushing strength can be produced. The density is deemed to be acceptable if it is at least 2.70 g/cm³ after coking the batch at 1,000° C. The cold crushing strength is deemed to be acceptable if it is at last 20 MPa after coking the batch at 1,000° C.

The carbon bonded refractory product according to the invention can be applied, e.g. in steel ladles or electric arc furnaces.

Further features of the invention will be apparent from the claims and the following exemplary embodiment of the invention.

All features of the invention may be combined, individually or in combination, in any desired manner.

The invention is explained in more detail with reference to the following exemplary embodiment:

### EXEMPLARY EMBODIMENT

In a first step, used refractory material having a carbon bond and used refractory material without a carbon bond were broken out from a furnace of a metallurgical plant.

The used refractory material having a carbon bond was present in the form of used carbon bonded magnesia bricks, i.e., so-called MgO—C bricks having a chemical composition of 94.0% by mass MgO and 6.0% by mass further oxides, in particular, Al₂O₃, CaO and SiO₂.

The used carbon bonded magnesia bricks further comprised carbon in an amount of 14.0% by mass, based on the total mass of the used carbon bonded refractory materials. These carbon fractions are not included in the aforementioned mass fractions of oxides, since they represent a loss of ignition when the oxide fractions are determined.

The used refractory material without a carbon bond was a sintered used magnesia refractory brick having a chemical composition with 94.0% by mass MgO and 6.0% by mass further oxides, in particular, Al₂O₃, CaO and SiO₂.

All of the above chemical compositions (i.e., the oxides) had been determined by XRF in accordance with the standard ISO 12677 (with reference to the fired sample, i.e., without reference to the carbon content).

The used refractory material having a carbon bond were comminuted to a grain size in the range of >0 to 5 mm and provided in a grain fraction of >0 to 2 mm and a grain fraction of >2 to 5 mm. Further the sintered used magnesia refractory brick was comminuted and provided in a grain size of >0 to 1 mm.

In the following, a batch for the production of a carbon bonded magnesia brick has been provided.

Therefore, the above-identified used carbon bonded magnesia bricks, comminuted to the grain size as set forth above, has been provided as used refractory material having a carbon bond within the meaning of the present invention. In Table 1 below, this material is denoted as “Used refractory with C bond”.

Further, the above-identified sintered used magnesia refractory brick, comminuted to the grain size as set forth above, has been provided as used refractory material without a carbon bond within the meaning of the present invention. In Table 1 below, this material is denoted as “Used refractory without C bond”.

In the following Table 1, formulations are given for two batches, one of which is designated A and the second B. The proportions of the components, as indicated in the first column of Table 1 for batch A and B, are given in % by mass, based in each case on the total mass of the respective batch.

TABLE 1

| Component | Batch ,,A“ | Batch ,,B“ |
|---|---|---|
| Used refractory with C bond (>2-5 mm) | 36 | 37 |
| Used refractory with C bond (>0-2 mm) | 40 | 48 |
| Used refractory without C bond (>0-1 mm) | 11 | — |
| Graphite | 8 | 10 |
| Pitch | 3 | 3 |
| Further components | 2 | 2 |

Batch A represents an exemplary embodiment of a batch according to the invention. The refractory component consisted of the used carbon bonded magnesia bricks (“Used refractory with C bond”) in grain fractions of >0 to 2 and 2 to 5 mm, and the sintered used magnesia refractory bricks (“Used refractory without C bond”) in a grain fraction of >0 to 1 mm. Pitch was used as the organic binder. Furthermore, the batch comprised a carbon-based component in the form of graphite (flake graphite).

Batch B was essentially the same as batch A. The main difference was that batch B did not comprise a component in the form of the sintered used magnesia refractory brick (“Used refractory without C bond”). Instead, batch B comprised a higher proportion of used carbon bonded magnesia bricks (“Used refractory with C bond”) in the finer grain fraction of >0 to 2 mm.

The d50 value of the used carbon bonded magnesia bricks (“Used refractory with C bond ”) for the grain fraction >2 to 5 mm had been measured by sieving according to the standard DIN EN 1402-3 and determined to be 3,150 μm.

The d50 value of the used carbon bonded magnesia bricks (“Used refractory with C bond”) for the grain fraction >0 to 2 mm had been measured by sieving according to the standard DIN EN 1402-3 and determined to be 700 μm.

The d50 value of the used carbon bonded magnesia bricks (“Used refractory with C bond ”) for the entire grain fraction >0 to 5 mm had been measured by sieving according to the standard DIN EN 1402-3 and determined to be 2,000 μm.

The d50 value of the sintered used magnesia refractory brick (“Used refractory without C bond”) had been measured by laser diffraction according to the standard ISO 13320:2020-1 and determined to be 500 μm.

The refractory component of batches A and B thus each had an essentially matching grain size distribution.

The chemical composition of batches A and B had been determined by XRF in accordance with the standard ISO 12677 and determined to be as indicated in Table 2.

TABLE 2

| Oxide | Batch ,,A“ | Batch ,,B“ |
|---|---|---|
| MgO | 94.1 | 94.0 |
| Al₂O₃ | 1.2 | 1.5 |
| CaO | 1.8 | 1.8 |
| SiO₂ | 1.4 | 1.5 |
| Other | 1.5 | 1.2 |

For the production of the carbon bonded magnesia brick from Batch A and B, each batch was mixed in a mixer, pressed into a green body and finally coked by subjecting the green body to a temperature of 200° C. for six hours, wherein the temperature came from used process heat. Afterwards, a carbon bonded magnesia brick was provided.

In order to determine whether the carbon bonded magnesia brick obtained from batch A and B has acceptable refractory properties, the density according to DIN EN 993-1 and the cold crushing strength according to DIN EN 993-5 were measured after coking at 1,000° C. The values for the brick obtained from batch A (“Brick A”) and for the brick obtained from batch B (“Brick B”) are given in Table 3 below.

TABLE 3

| Property | Brick A | Brick B |
|---|---|---|
| Density [g/cm³] | 2.72 | 2.68 |
| Cold crushing strength [MPa] | 20 | 18 |

According to this, it can be seen that Brick A has both a higher density and a significantly higher cold crushing strength than Brick B.

Overall, the refractory values of brick A, although it even had a higher percentage of used refractory material than brick B, were still acceptable, in contrast to the values of brick B.

1. A batch for the production of a carbon bonded refractory product comprising the following components:
1.1 a refractory component; and
1.2 an organic binder; wherein
1.3 said refractory component comprises
1.3.1 at least one used refractory material having a carbon bond and
1.3.2 at least one used refractory material without a carbon bond; wherein
1.4 said at least one used refractory material having a carbon bond has a particle-size distribution having a first d50 value; and
1.5 said at least one used refractory material without a carbon bond has a particle-size distribution having a second d50 value; and wherein
1.6 said first d50 value is higher than said second d50 value; and wherein
1.7 said at least one used refractory material having a carbon bond is present in a proportion in the range of 80 to 99% by mass and said at least one used refractory material without a carbon bond is present in a proportion in the range of 1 to 20% by mass, each based on the total mass of the said refractory component.

2. The batch according to claim 1, wherein said first d50 value is higher than said second d50 value by at least a factor of 4.

3. The batch according to claim 1, wherein said first d50 value is at least 500 μm.

4. The batch according to claim 1, wherein said second d50 value is not above 400 μm.

5. The batch according to claim 1, wherein said at least one used refractory material having a carbon bond is comprised of at least one of the following: used carbon bonded magnesia-based refractory materials and used carbon bonded alumina-magnesia-based refractory materials.

6. The batch according to claim 1, wherein said at least one used refractory material without a carbon bond is comprised of at least one of the following: used magnesia-based refractory materials and used alumina-magnesia-based refractory materials.

7. The batch according to claim 1, wherein
said at least one used refractory material having a carbon bond is comprised of at least one of the following: magnesia-based refractory materials having a carbon bond and alumina-magnesia-based refractory materials having a carbon bond; and wherein
said at least one used refractory material without a carbon bond is comprised of magnesia-based refractory materials without a carbon bond and alumina-magnesia-based refractory materials without a carbon bond.

8. The batch according to claim 1, wherein the batch further comprises a carbon-based component.

9. The batch according to claim 8 with the carbon-based component in the form of graphite.

10. The batch according to claim 1, wherein the organic binder is pitch.

11. The batch according to claim 1, wherein the organic binder comprises lignin.

12. The batch according to claim 11, wherein the organic binder comprises at least 10% by mass of lignin, based on the total mass of the organic binder.

13. A process for the production of a carbon bonded refractory product comprising the following steps:
A. providing the batch according to claim 1; and
B. subjecting the batch to temperature to produce a carbon bonded refractory product.

14. The process of claim 13, further comprising the step of breaking out used refractory material having a carbon bond from at least one aggregate for treating molten metal and then providing said broken out used refractory material to provide said at least one used refractory material having a carbon bond.
